(19) United States
(12) Patent Application Publication
(10) Pub. No.: US 2017/0091401 A1
(43) Pub. Date: Mar. 30, 2017

(54) SYSTEM AND METHOD FOR DETERMINING A HEATHCARE UTILIZATION RATE SCORE

(71) Applicant: Innodata Synodex, LLC, Hackensack, NJ (US)

(72) Inventor: Richard D. Kemp, Edgewater, NJ (US)

(73) Assignee: Innodata Synodex, LLC, Hackensack, NJ (US)

(21) Appl. No.: 15/271,885

(22) Filed: Sep. 21, 2016

Related U.S. Application Data
(60) Provisional application No. 62/222,818, filed on Sep. 24, 2015.

(51) Int. Cl. G06F 19/00

(52) U.S. Cl. CPC G06F 19/328; G06F 19/322; G06F 19/345

(57) ABSTRACT

Systems and methods for determining an assessment of a user include receiving insurance claim information of a user. Claim data indicative of a healthcare utilization rate is extracted from the insurance claim information. A healthcare utilization rate score is computed based on the extracted claim data. An assessment of the user is determined based on the healthcare utilization rate score.

### CROSS-REFERENCE TO RELATED APPLICATIONS

This application claims the benefit of Provisional Application No. 62/222,818, filed Sep. 24, 2015, the disclosure of which is herein incorporated by reference in its entirety.

### BACKGROUND OF THE INVENTION

The present invention relates generally to determining a healthcare utilization rate score, and more particularly to assessing the health status of an individual based on a healthcare utilization rate score.

Current practices for assessing an individual's health status involve long and tedious processes. For example, the health status of an individual may be determined by medical record processing. This may involve obtaining consent to access the medical records from the individual, ordering the medical records from healthcare providers, and analyzing the medical records to identify the relevant information. This process may take weeks to complete. This delay in health status assessment may result in the health status of the individual becoming stale or the individual losing interest in the product for which the health status was determined for. The processing of medical records is also a long and tedious task, which may involve collecting medical records stored at disparate locations and analyzing the medical records for relevant information. What is needed is a fast and efficient approach to assess a health status of an individual.

### BRIEF SUMMARY OF THE INVENTION

Systems and methods for determining an assessment of a user include receiving insurance claim information of a user. Claim data indicative of a healthcare utilization rate is extracted from the insurance claim information. A healthcare utilization rate score is computed based on the extracted claim data. An assessment of the user is determined based on the healthcare utilization rate score.

These and other advantages of the invention will be apparent to those of ordinary skill in the art by reference to the following detailed description and the accompanying drawings.

### BRIEF DESCRIPTION OF THE DRAWINGS

FIG. 1 shows a block diagram of a system for determining an assessment of an individual;

FIG. 2 shows a detailed view of an assessment system for determining an assessment of an individual;

FIG. 3 shows an exemplary healthcare utilization rate score report;

FIG. 4 shows a flow diagram of a method for determining an assessment of a user;

FIG. 5 shows a flow diagram of a method for validating an application for insurance; and

FIG. 6 shows a high-level block diagram of a computer for determining an assessment of a user.

### DETAILED DESCRIPTION

The fast and efficient determination of an individual's health status may be beneficial in the assessment of many different applications. For example, existing approaches to assessing an insurability of an applicant for life insurance may involve paramedical examination or a full attending physician statement (APS) review process, which may be time consuming (averaging around 13 days), expensive, invasive, and not responsive to the mobile and fast paced electronic decision systems of other internet based products. However, insurance underwriters cannot ignore the health of the applicants, nor can they price-in significant health issues into all policies, which would raise the overall cost of insurance. Advantageously, the fast and efficient determination of an individual's health status based on a healthcare utilization rate score may allow an insurance underwriter to provide an assessment for life insurance, long-term care insurance, disability insurance, etc. in a very short time period (e.g., minutes). Such a shortening of the production cycle for providing an assessment of insurability allows an applicant to sign up for insurance before he or she loses interest or changes his or her mind.

Other examples where the fast and efficient determination of an individual's health status may be beneficial include assessing the eligibility of donors to donate blood or assessing the ability of an individual to participate in physically strenuous activities such as, e.g., skydiving, riding rollercoasters, etc. to reduce liability. The fast and efficient determination of an individual's health status may also be employed in other applications.

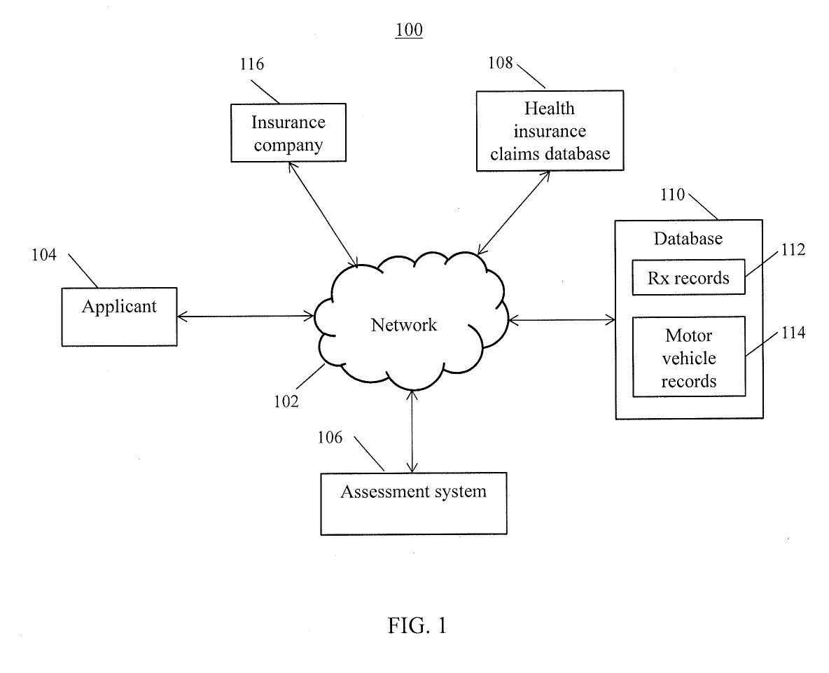

FIG. 1 shows a block diagram of a system 100 for determining an assessment of an individual, in accordance with one or more embodiments. For example, system 100 may be employed for determining a health status of an applicant for providing an assessment of insurability of the applicant based on a healthcare utilization rate score. In free-market conditions, insurance underwriters typically operate independently, and each independent insurer will evaluate similar medical conditions (e.g., disease, risk of disease, etc.) and other risk factors according to their own risk standards. Insurance underwriters may initially assign each person with 100% of the standard mortality risk for a given age, gender, occupation, location of residence, and/or any other relevant consideration. Their mortality risk may then be adjusted according to different risks accepted by the underwriter. In one embodiment, the mortality risk of an individual may be adjusted based on a healthcare utilization rate score using health insurance claim data.

It should be understood that while the embodiments discussed herein are described in relation to determining a health status of an individual for providing an assessment of insurability, these embodiments may be employed in a number of different applications and are not limited to insurance underwriting.

System 100 includes network 102 to facilitate communication between entities via a plurality of network devices, including, e.g., applicant 104, assessment system 106, health insurance claims database 108, database 110, and insurance company 116. Network 102 may include one or more of a wired or wireless network, and may be a local area network (LAN), a wide area network (WAN), a cellular network, the Internet, or any other configuration to facilitate communication between the plurality of network devices.

Applicant 104 may employ a computing device to submit an application, e.g., for an insurance product. The computing device of applicant 104 may include, for example, a computer, a tablet, a mobile phone or device, a kiosk, or any other computing device capable of communicating over network 102. Applicant 104 employs the computing device for submitting the application for an insurance product to an insurance underwriter of insurance company 116. In one example, the applicant submits the application via a website associated with an insurance underwriter accessed using the computing device. In another example, the applicant submits the application via an application (e.g., an app) associated with an insurance underwriter running on the computing device. Other approaches for submitting the application to insurance company 116 are also contemplated.

The application for insurance may include information of the applicant, such as, e.g., age, gender, occupation, location of residence, and/or any other relevant information. For example, the application for insurance may also include information indicative of the mortality risk of the applicant.

In some embodiments, the application may also include consent from applicant 104 allowing insurance company 116 (or another party such as, e.g., assessment system 106) to access the health insurance claims of applicant 104 stored in health insurance claims database 108 (or other data stored in database 110 such as, e.g., medical prescription (Rx) records 112 and motor vehicle records 114). For example, consent may be provided by applicant 104 by submitting an electronic consent form to insurance company 116. The electronic consent form may include personal information of applicant 104 (e.g., name, date of birth, social security number, etc.) along with a statement of consent.

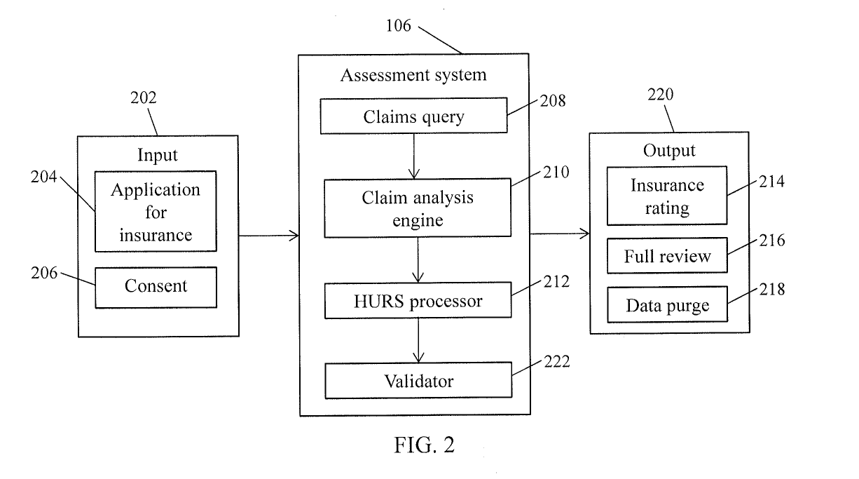

Insurance company 116 transmits the application for insurance and consent to assessment system 106 for determining an assessment of applicant 104 via network 102. Referring now to FIG. 2, with continued reference to FIG. 1, assessment system 106 is shown is more detail. Assessment system 106 receives the application for insurance 204 and consent 206 (if provided by applicant 104) as input 202.

Claims query 206 processes application 204 and consent 206. If consent 206 is not provided by applicant 104, assessment system 106 automatically redirects application 204 into a full APS review process 216 as output 220. If consent 206 is provided by applicant 104, claims query 208 of assessment system 106 generates a request for insurance claim information of applicant 104. The request may include application 204 and consent 206. The request is transmitted to insurance claims database 108.

Claims query 208 interacts with one or more insurance claims databases 108, each of which may be associated with a server of a health insurance provider, to obtain select claim information of applicant 104. The claim information may be provided in real time or near real time. In some embodiments, a fee may be provided to the health insurance provider for expedited access to claim information. While insurance claims database 108 is shown in system 100 as a single entity, it should be appreciated that system 100 may include any number of insurance claims databases 108 located at a same or disparate locations and connected to network 102 or other networks. For example, each of a plurality of insurance claims databases 108 may be associated with different health insurance providers that the applicant used over different periods of time.

Claims query 208 may retrieve any health insurance claim information of applicant 104 indicative of a healthcare utilization rate of the applicant. For example, insurance claim information retrieved by claims query 208 may include, e.g., information of the healthcare providers, a specialization of the healthcare providers (if any), claims that were appealed, billing amounts associated with the claims, and diagnosis codes associated with the claims such as, e.g., International Classification of Diseases, Ninth Revision (ICD9) or ICD10 codes. The claim information may also include any other relevant insurance claim data or metadata.

In one embodiment, consent 206 is reviewed to determine if the personal information of applicant 104 matches the information in the retrieved insurance claim information. For example, insurance claims database 108 may verify that the personal information of applicant 104 indicated in the consent matches the information in the insurance claim information before releasing the insurance claim information. In another example, claims query 208 verifies that the personal information of applicant 104 indicated in the consent matches the information in the insurance claim information before further processing. This review process may be automated or manually performed.

In some embodiments, consent 206 includes consent to access additional information of applicant 104, such as, e.g., additional information of applicant 104 stored in database 110. In this embodiment, claims query 208 may also submit a request for additional information of applicant 104 to database 110. For example, insurance company 116 may request Rx records 112, motor vehicle records 114, etc. Database 110 may also store other data of applicant 104. It should be understood that database 110 may store records at a single location or at disparate locations, and may be owned by a same entity or different entities. In response to the request, database 110 may transmit the additional information of applicant 104 to claims query 208. The additional information may be processed by assessment system 106 in a similar manner as the insurance claim information received from insurance claims database 108.

Claims query 208 receives the claim information from insurance claims database 108 (and/or additional information from database 110) and forwards the claim information to claim analysis engine 210 of assessment system 106 for analysis. Claim analysis engine 210 analyzes the claim information by extracting claim data from the claim information, which is used to determine a healthcare utilization rate score. The extracted claim data may be associated with any factor indicative of mortality of the applicant. The factors considered for determining the healthcare utilization rate score may vary between different insurance underwriters, e.g., based on a level of risk that an insurance underwriter deems acceptable.

In one embodiment, the factors associated with the extracted claim data are indicative of the extent of use of the healthcare system by the applicant. For example, the factors may include particular diagnosis codes, amount of claims, frequency of claims, types of physicians associated with the claims, etc. In particular, the factors may be based on one or more of: insurance claims, a type of claim (e.g., physician claims, laboratory claims, diagnostic testing claims, prescription drug claims, and surgical claims), months in which a claim was made, different physicians seen by the applicant, active prescription claims, total prescriptions filled, lab tests, medical procedures, health claims appeals, diagnosis codes (e.g., ICD9, ICD10), frequency of the diagnosis codes, and doctor office visits. For example, the extracted claim data may include a number and/or rate associated with the factors. The number associated with the factors may include an overall total number or a number for a predetermined time period (e.g., month, year, etc.). In some embodiments, the extracted claim data may also include detailed information associated with the factors, such as, e.g., a billing amount associated with each diagnosis code, dates associated with each claim, the presence of specific diagnosis codes such as those associated with high mortality risk, etc. Other factors may also be employed within the context of the present principles.

HURS processor 212 computes a healthcare utilization rate score of the applicant based on the extracted claim data. The healthcare utilization rate score represents an extent of the applicant's use of the healthcare system, as compared to the average applicant having a same or similar age, gender, occupation, location of residence, and/or any other consideration. HURS processor 212 computes the healthcare utilization rate score according to a scoring algorithm. The scoring algorithm may be individually determined by the insurance underwriter based on a level of risk the underwriter is willing to accept.

In one embodiment, scoring algorithm includes a machine learning algorithm. The machine learning algorithm may learn claim patterns during a training phase using training data. The training data may include training extracted claim data that is annotated with its assessment or score. The machine learning algorithm is applied to the extracted claim data during an online phase. In one embodiment, in order to create a learning model, claims patterns can be compared to actual risk scores obtained from traditional methods. For example, the claims patterns may be represented as follows: pattern 1—recent high medical activity; pattern 2—no recent medical activity; pattern 3—regular normal medical activity; pattern 4—chronic disease pattern, pattern 5—disease out of control; and pattern 6—regular repetition of certain diagnosis codes. The claims patterns can be comparable to actual APS outcomes for correlations to learn the models.

The healthcare utilization rate score represents a health status of the applicant based on the applicant's rate of use of the healthcare system relative to the applicant's expected use of the healthcare system for his or her age, gender, occupation, location of residence, and/or any other consideration. The healthcare utilization rate score may generally indicate whether the applicant's use of the healthcare system is below average, average, or above average relative to the applicant's expected use. For example, below average use of the healthcare system for a twenty year old college student may not evidence risk and thus lower than expected activity may be neutral. However, above average use of the healthcare system by the twenty year old college student would indicate some type of health condition. The healthcare utilization rate score may be determined based on a composite of the factors using available insurance claims information.

In one exemplary embodiment of the healthcare utilization rate score, a score of 100 (or close to 100) may indicate that the applicant uses the healthcare system as expected, and thus is expected to be in average health for his or her age, gender, occupation, location of residence, etc. A score of 100 may also indicate that the applicant's extracted claim information did not reveal any high risk indicators, such as, e.g., the presence of specific diagnosis codes, large claim billing amounts, a cluster of repetitive claims, etc. A score below 100 may indicate a lower than expected use of the healthcare system, which may indicate the existence of a risk or may be a neutral indicator depending on the amount of insurance and the applicant's age, gender, occupation, location of residence, etc. A score of zero indicates no use of the healthcare system. A score above 100 indicates above average use of the healthcare system, and may indicate developing medical issues, symptoms, or other areas of health concern. Other approaches to implementing a healthcare utilization rate score are also contemplated.

Evidence of below average use of the healthcare system (e.g., a score below 100) may include, e.g., a low number (e.g., total, number for a predetermined time period, an average, etc.) of claims, a low number of diagnosis code billings, a low dollar amount of claim billings, etc. as compared to the expected use of the healthcare system for a given age, gender, occupation, location of residence, etc. Other factors may also be used to evidence below average use of the healthcare system. Below average use of the healthcare system may provide no negative inferences as to the health status of the applicant (depending on the applicant's age, gender, occupation, etc.), however may also provide no positive inferences as to the health status of the applicant. For example, an applicant who makes no use of the healthcare system would indicate that there are no known health issues being actively treated, but also indicates that the applicant does not go for regular checkups.

Average use of the healthcare system (e.g., a score of or close to 100) may be evidenced by, e.g., a regular pattern of doctor visits, which may use similar factors as discussed above with respect to the below average use of the healthcare system. Average use of the healthcare system may also be evidence by the absence of any high risk indicators in the applicant's extracted claim information, such as, e.g., the presence of specific diagnosis codes, large claim billing amounts, a cluster of claims, repetition of particular diagnosis codes, etc. Average use of the healthcare system may indicate that the applicant is expected to be in average health.

Above average use of the healthcare system (e.g., a score above 100) may be evidenced by, e.g., a high number (e.g., a total number, number for a predetermined time period, an average, etc.) of claims, a high number of particular diagnosis codes, a repetitive pattern of diagnosis codes, a clustering of claims, claims associated with a high risk specialist, the presence of specific diagnosis codes (e.g., surgical claims, codes association with infection), large claim billing amounts, etc.

In one embodiment, HURS processor 212 determines a healthcare utilization rate score by weighting the factors. For example, the factors may be weighted based on date of the claim information such that factors associated with the most recent claim information is given more weight than factors associated with older claim information. In other examples, factors may be weighted based on a clustering of claims (e.g., a number of claims within a predetermined time period may be given more weight), repetitive claims (e.g., claims repeating more than a predetermined number over a predetermined period of time may be given more weight), associated billing amounts (e.g., claims associated with billing amounts over a predetermined amount may be given more weight), or based on the diagnosis code (e.g., claims associated with high risk diagnosis codes or other predetermined diagnosis codes may be given more weight). The factors may also be weighted based on other criteria.

Based on the healthcare utilization rate score, HURS processor 212 determines an insurance rating 214 as output 220. In one embodiment, ranges of healthcare utilization rate scores may be mapped to one of a plurality of assessment categories to determined insurance rating 214. For example, the assessment categories may include preferred, standard, impaired, declined, postponed, full APS review, details required, and unable to determine. Other categories may also be used. In some embodiments, the assessment of the applicant into one of the plurality of categories may also be based on additional criteria. For example, the presence of predetermined diagnosis codes associated with a high mortality risk will result in an assessment of unable to determine, regardless of the healthcare utilization rate score. In one embodiment, output 220 may also include a data purge 218 to purge all raw data after processing.

In one embodiment, assessment system 106 may also include validator 222 to validate the accuracy of the application based on the claim information received from insurance claims database 108. For example, the applicant's statement made in the application that he or she receives annual doctor checkups may be validated based on the claim information. In one embodiment, an accuracy of the application is verified prior to the transmission of the offer of insurance. In other embodiments, the offer of insurance may be contingent upon the accuracy of the application. In still other embodiments, the accuracy of the application is considered in determining the healthcare utilization rate score or assessment (e.g., applications that are inconsistent with the extracted claim data may be automatically assessed as unable to determine).

In one embodiment, HURS processor 212 may additionally and/or alternatively computes a mortality score from the claim information. The score may be represented relative to a standard score for an applicant of a given age, gender, and location. For example, applicant 104 may initially be assigned a score of 100 indicating that applicant 104 is assigned 100% of the standard table mortality for a given age, gender, and location. The score may then be adjusted based on the claim information. The score may represent a correlation between the claim activity pattern and mortality and morbidity risks. In some embodiments, the score may be determined based on machine learning algorithms to learn a mapping of claim patterns to mortality and morbidity risks. The correlation may be used in determining the assessment.

Based on the assessment, assessment system 106 may transmit a response to the application to computing device of applicant 104. In one embodiment, the response may include an offer of insurance, an indication that insurance coverage is declined, or an indication that a full medical review (e.g., APS review) is required before an offer of insurance can be made. For example, an assessment of preferred or standard may result in an offer of insurance, an assessment of impaired, postponed, full APS, details required, or unable to determine may result in an indication that a full medical review is required, and an assessment of declined may result in an indication that insurance coverage is declined.

In some embodiments, an offer of insurance may include a price quote determined based on the healthcare utilization rate score. In one example, pricing for low and expected healthcare utilization rate score may fit within predetermined pricing guidelines for the applicant's age, gender, occupation, location of residence, amount of insurance, and/or other considerations. In this example, an applicant may initially be given a standard price for his or her age, gender, occupation, and location of residence, which is then adjusted up or down within predetermined limits based on the healthcare utilization rate score.

Advantageously, healthcare utilization rate scores may be calculated in real time or near real time based on insurance claim information of the applicant to determine a health status of the applicant. As such, the healthcare utilization rate scores may be used to generate quotes for offers of insurance with minimal delay to thereby shorten the production cycle for insurance underwriting and streamline the insurance application process for many applicants.

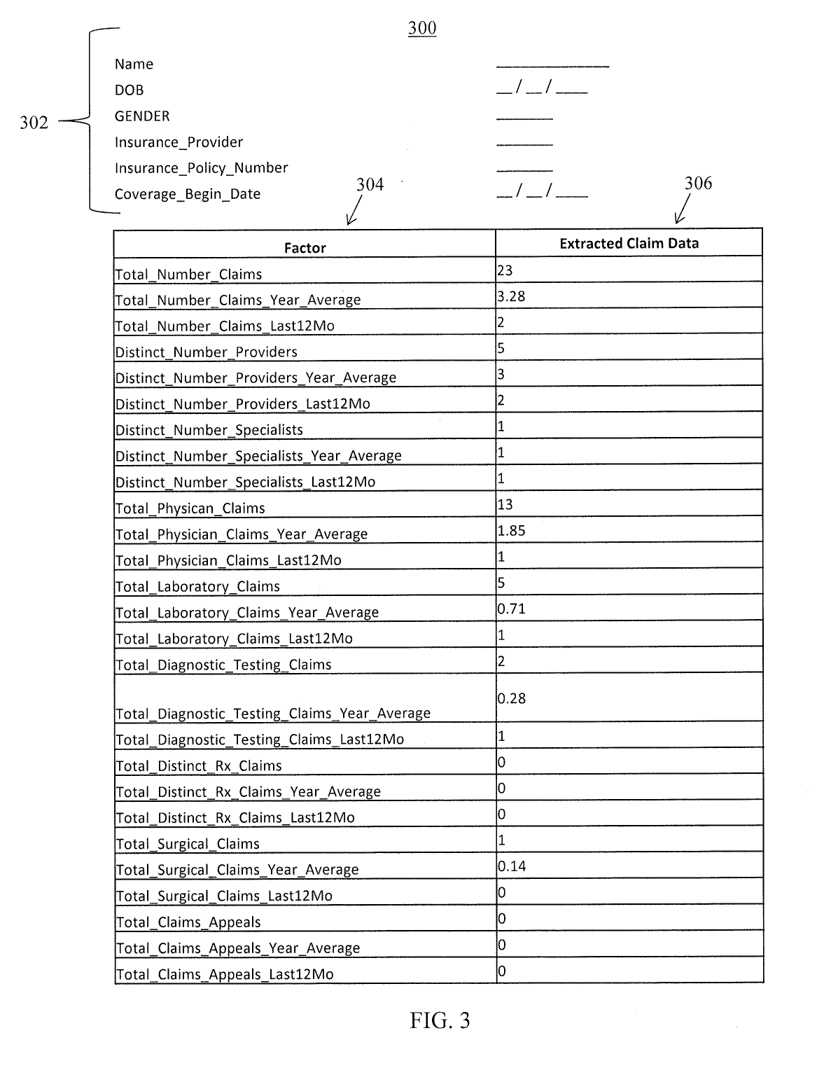

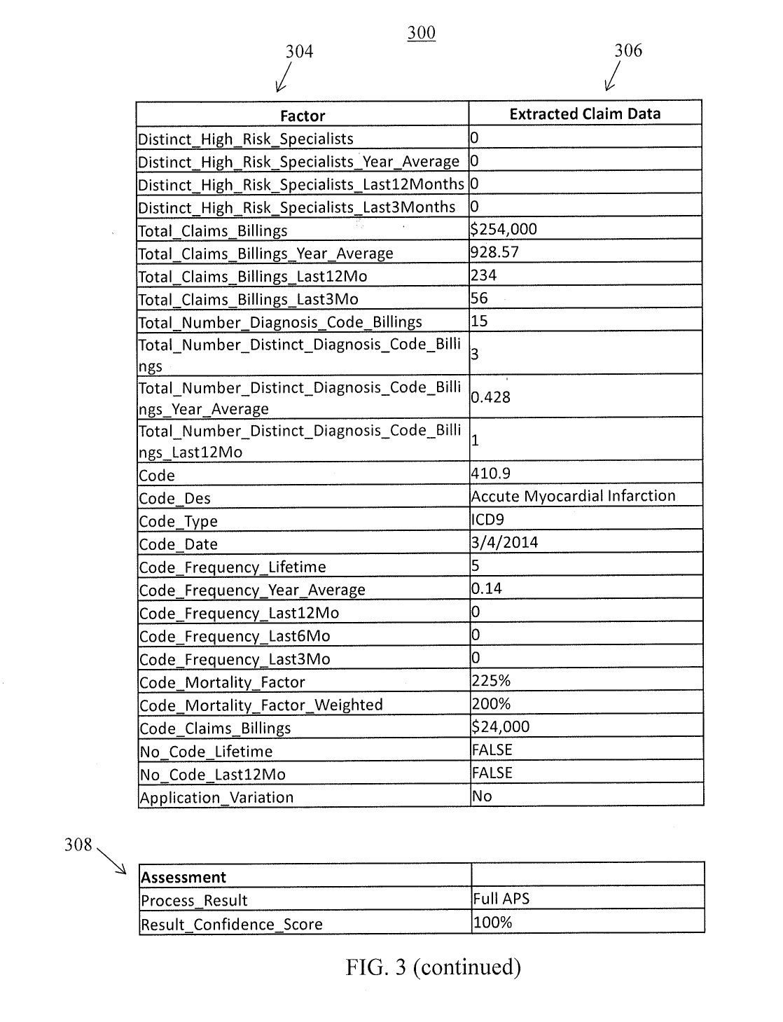

FIG. 3 shows an exemplary healthcare utilization rate score report 300, in accordance with one or more embodiments. Report 300 may be generated by HURS processor 212 as part of the assessment. Report 300 includes applicant information 302, along with factors 304 indicative of a healthcare utilization rate and associated extracted claim data 306. Factors 304 are selected by the insurance underwriter according to his or her level of acceptable risk and the availability of insurance claim information. Extracted claim data 306 includes data extracted from the applicant's insurance claims and associated with factors 304. Based on extracted claim data 306, HURS processor 212 determines an assessment 308 of full APS review with an associated confidence score. The confidence score may be based on an amount of data available. For instance, if sufficient data is available, the confidence score would be high. In one example, if records are available for 3 years of claims, the use of the healthcare system is as expected for a given age and gender, and no serious diseases are being billed for or disclosed nt he application, this applicant may be given a standard rate (determined by a pricing actuary).

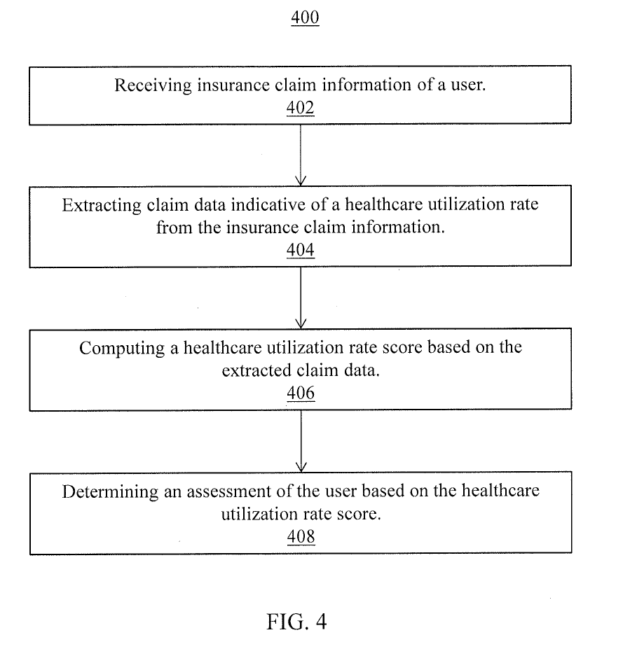

FIG. 4 shows a flow diagram of a method 400 for determining a health status of a user (e.g., an applicant for life insurance), in accordance with one or more embodiments. Method 400 may be performed by, e.g., assessment system 106. The health status of a user may be used for, e.g., providing an assessment of insurability. Advantageously, method 400 allows for a shortened production cycle for providing an assessment of insurability based on the health status of a user.

At step 402, insurance claim information of a user is received. The insurance claim information may be received in response to a request, e.g., to one or more health insurance providers. The request may be submitted based on an application for insurance received from the user. The request for insurance claim information may include consent from the user consenting to access to his or her insurance claim information. The consent may have initially been received from the user in the application for insurance. The application for insurance may also include information indicative of the mortality risk of the user.

At step 404, claim data indicative of a healthcare utilization rate is extracted from the insurance claim information. The extracted claim data may include, e.g., a number of claims made, a number of months in which a claim was made, a number of different physicians associated with the insurance claim information, a number of prescription claims made, a number of laboratory test claims made, and a frequency of diagnosis codes. The number may include a total number or a number for a predetermined time period (e.g., month, year). Other claim data may also be extracted.

At step 406, a healthcare utilization rate score is computed based on the extracted claim data. The healthcare utilization rate score represents the extent of the user's use of the healthcare system as compared to the average applicant having a same or similar age, gender, occupation, location of residence, etc. For example, the healthcare utilization rate score may be represented as a variance from a base score. In one embodiment, a base score of 100 represents that the user is expected to use an average amount of the healthcare system and therefore the user is expected to be in average health. A score above 100 represents above average use of the healthcare system and indicates health risk of the user. A score below 100 represents below average use of the healthcare system and may indicate risk or may be neutral (depending on the user's age, gender, location, etc.). Other approaches for a healthcare utilization rate score may also be employed. In some embodiments, the healthcare utilization rate score is computed by weighting the extracted claim data, e.g., based on date, a clustering of claims, repeating claims, billing amounts, diagnosis code, etc.

At step 408, an assessment of the user is determined based on the healthcare utilization rate score. In one embodiment, the assessment of the user includes an assessment of insurability of the user. For example, the assessment may be one of a plurality of categories, e.g., preferred, standard, impaired, declined, and unable to determine. The assessment may be based on criteria in addition to the healthcare utilization rate score, such as, e.g., an accuracy of the application, the presence of particular diagnosis codes, a billing amount, etc. For example, applications determined to be inconsistent with the insurance claim information are assessed unable to determine.

Based on the assessment, a response is sent to the user. For example, an assessment of preferred or standard may result in an offer of insurance, an assessment of impaired or unable to determine may result in an indication that a full medical review is required, and an assessment of declined may result in an indication that insurance coverage is declined. In some embodiments, an offer of insurance may include a price quote determined based on the healthcare utilization rate score. The fast and efficient determination of a user's health status allows for the shortening of the production cycle for providing an offer of insurance.

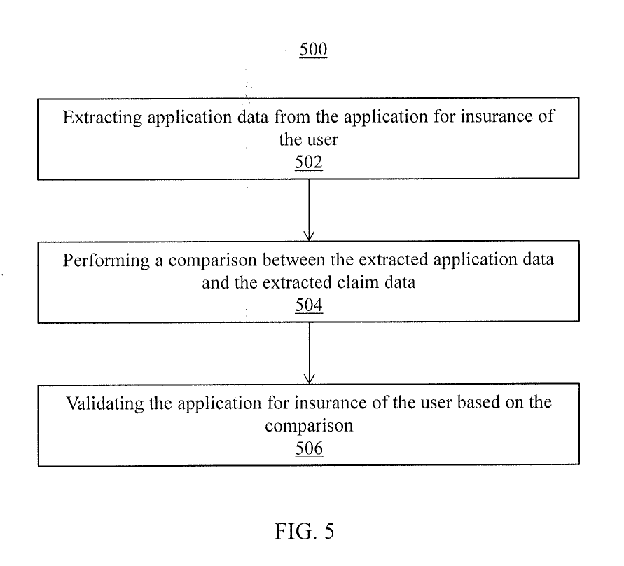

FIG. 5 shows a flow diagram of a method 500 for validating an application for insurance using the insurance claim information, in accordance with one or more embodiments. Method 500 may be performed by, e.g., validator 222 of assessment system 106. At step 502, application data is extracted from the application for insurance of the user. At step 504, a comparison is performed between the extracted application data and the extracted claim data. The extracted claim data may be extracted by claims query 208 and claim analysis engine 210 of assessment system 106. At step 506, the application for insurance is validated based on the comparison. In one example, the extracted application data may comprise the question “Have you consulted with or been treated by a physician within the last five years?” in a questionnaire of the application and the associated answer from the applicant of “No.” The extracted claim data may indicated that the applicant has made ten doctor visits within the last five years. The comparison would then show that the applicant has not fully disclosed his or her medical history.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 4 and 5. Certain steps of the methods described herein, including one or more of the steps of FIGS. 4 and 5, may be performed by a server or by another processor in a network-based cloud-computing system. Certain steps of the methods described herein, including one or more of the steps of FIGS. 4 and 5, may be performed by a client computer in a network-based cloud computing system. The steps of the methods described herein, including one or more of the steps of FIGS. 4 and 5, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 4 and 5, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

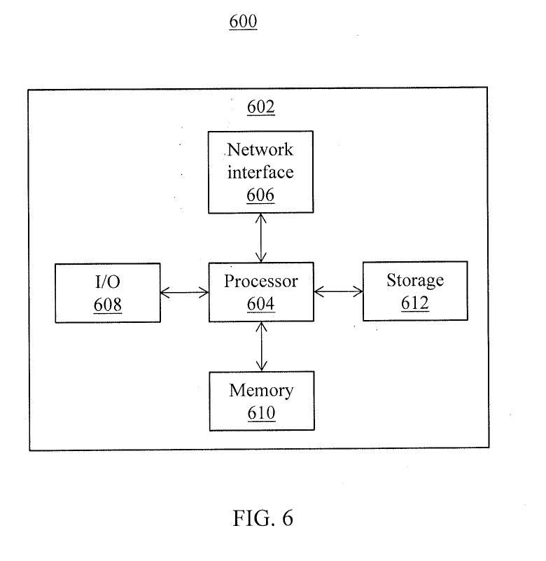

A high-level block diagram 600 of an example computer that may be used to implement systems, apparatus, and methods described herein is depicted in FIG. 6. Computer 602 includes a processor 604 operatively coupled to a data storage device 612 and a memory 610. Processor 604 controls the overall operation of computer 602 by executing computer program instructions that define such operations. The computer program instructions may be stored in data storage device 612, or other computer readable medium, and loaded into memory 610 when execution of the computer program instructions is desired. Thus, the method steps of FIGS. 4 and 5 can be defined by the computer program instructions stored in memory 610 and/or data storage device 612 and controlled by processor 604 executing the computer program instructions. For example, the computer program instructions can be implemented as computer executable code programmed by one skilled in the art to perform the method steps of FIGS. 4 and 5. Accordingly, by executing the computer program instructions, the processor 604 executes the method steps of FIGS. 4 and 5. Computer 602 may also include one or more network interfaces 606 for communicating with other devices via a network. Computer 602 may also include one or more input/output devices 408 that enable user interaction with computer 602 (e.g., display, keyboard, mouse, speakers, buttons, etc.).

Processor 604 may include both general and special purpose microprocessors, and may be the sole processor or one of multiple processors of computer 602. Processor 604 may include one or more central processing units (CPUs), for example. Processor 604, data storage device 612, and/or memory 610 may include, be supplemented by, or incorporated in, one or more application-specific integrated circuits (ASICs) and/or one or more field programmable gate arrays (FPGAs).

Data storage device 612 and memory 610 each include a tangible non-transitory computer readable storage medium. Data storage device 612, and memory 610, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 608 may include peripherals, such as a printer, scanner, display screen, etc. For example, input/output devices 608 may include a display device such as a cathode ray tube (CRT) or liquid crystal display (LCD) monitor for displaying information to the user, a keyboard, and a pointing device such as a mouse or a trackball by which the user can provide input to computer 602.

Any or all of the systems and apparatus discussed herein, including assessment system 106, insurance claims database 108, database 110, and devices associated with applicant 104 and insurance company 116 of system 100 of FIGS. 1 and 2, may be implemented using one or more computers such as computer 602.

One skilled in the art will recognize that an implementation of an actual computer or computer system may have other structures and may contain other components as well, and that FIG. 6 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for determining an assessment of a user, comprising:
receiving insurance claim information of a user;
extracting claim data indicative of a healthcare utilization rate from the insurance claim information;
computing a healthcare utilization rate score based on the extracted claim data; and
determining an assessment of the user based on the healthcare utilization rate score.

2. The method as recited in claim 1, wherein the computing a healthcare utilization rate score based on the extracted claim data further comprises:
comparing the extracted claim data indicative of the healthcare utilization rate with an expected healthcare utilization rate of the user.

3. The method as recited in claim 1, wherein the computing a healthcare utilization rate score based on the extracted claim data further comprises:
weighting the extracted claim data based on at least one of: a date associated with the extracted claim data, a clustering of claims within a predetermined time period, repeating claims, billing amounts associated with the extracted claim data, and an associated diagnosis code.

4. The method as recited in claim 1, further comprising:
computing a mortality score based on the extracted claim data.

5. The method as recited in claim 1, further comprising:
obtaining an attending physician statement based on the health assessment of the user.

6. The method as recited in claim 1, further comprising:
receiving an application for insurance from the user; and
validating that the application for insurance is accurate based on the insurance claim information.

7. The method as recited in 6, wherein the application for insurance includes consent to access the insurance claim information from the user.

8. The method as recited in claim 1, further comprising:
transmitting a price quote for insurance to the user, the price quote being determined based on the healthcare utilization rate score.

9. The method as recited in claim 1, further comprising:
determining a correlation between patterns in the extracted claim data indicative of the healthcare utilization rate and at least one of mortality and morbidity.

10. The method as recited in claim 1, wherein the determining a correlation between patterns in the extracted claim data indicative of the healthcare utilization rate and at least one of mortality and morbidity further comprises:
applying machine learning algorithms to learn correlations between patterns in the extracted claim data indicative of the healthcare utilization rate and the at least one of mortality and morbidity.

11. The method as recited in claim 1, wherein the extracted claim data indicative of the healthcare utilization rate is based at least one of:
a number of claims made over a predetermined time period, a number of months in which a claim was made over the predetermined time period, a number of different physicians associated with the insurance claim information over the predetermined time period, a number of prescription claims made over the predetermined time period, a number of laboratory test claims made over the predetermined time period, and a frequency of diagnosis codes.

12. A system for determining an assessment of a user, comprising:
a processor; and
a memory to store computer program instructions, the computer program instructions when executed on the processor cause the processor to perform operations comprising:
receiving insurance claim information of a user;
extracting claim data indicative of a healthcare utilization rate from the insurance claim information;
computing a healthcare utilization rate score based on the extracted claim data; and
determining an assessment of the user based on the healthcare utilization rate score.

13. The system as recited in claim 12, wherein the computing a healthcare utilization rate score based on the extracted claim data further comprises:
comparing the extracted claim data indicative of the healthcare utilization rate with an expected healthcare utilization rate of the user.

14. The system as recited in claim 13, wherein the expected healthcare utilization rate of the user is based on an age, gender, and occupation of the user.

15. The system as recited in claim 12, wherein the computing a healthcare utilization rate score based on the extracted claim data further comprises:
weighting the extracted claim data based on at least one of: a date associated with the extracted claim data, a clustering of claims within a predetermined time period, repeating claims, billing amounts associated with the extracted claim data, and an associated diagnosis code.

16. The system as recited in claim 12, the operations further comprising:
obtaining an attending physician statement based on the health assessment of the user.

17. The system as recited in claim 12, the operations further comprising:
receiving an application for insurance from the user; and
validating that the application for insurance is accurate based on the insurance claim information.

18. A computer readable medium storing computer program instructions for determining an assessment of a user, which, when executed on a processor, cause the processor to perform operations comprising:
receiving insurance claim information of a user;
extracting claim data indicative of a healthcare utilization rate from the insurance claim information;
computing a healthcare utilization rate score based on the extracted claim data; and
determining an assessment of the user based on the healthcare utilization rate score.

19. The computer readable medium as recited in claim 18, the operations further comprising:
transmitting a price quote for insurance to the user, the price quote being determined based on the healthcare utilization rate score.

20. The computer readable medium as recited in claim 18, the operations further comprising:
determining a correlation between patterns in the extracted claim data indicative of the healthcare utilization rate and at least one of mortality and morbidity.
